(19) United States
(12) Patent Application Publication
(10) Pub. No.: US 2009/0161277 A1
(43) Pub. Date: Jun. 25, 2009

(54) METHOD AND DEVICE FOR PREVENTING DAMAGE TO A SEMICONDUCTOR SWITCH CIRCUIT DURING A FAILURE

(76) Inventors: Robert Roesner, Munchen (DE); Kanakasabapathi Subramanian, Clifton Park, NY (US)

Correspondence Address: General Electric Company;GE Global Patent Operation, PO Box 861, 2 Corporate Drive, Suite 648, Shelton, CT, 06484, US

(21) Appl. No.: 11/962,830

(22) Filed: Dec. 21, 2007

(51) Int. Cl. H02H 3/00

(52) U.S. Cl. 361/87

(57) ABSTRACT

A device includes at least one semiconductor switching circuit connected to a power source and a load and at least one breaker switch integrated with the at least one semiconductor switching circuit. The breaker circuit may be connected in series with the at least one semiconductor switching circuit and the at least one breaker switch is configured to create an open circuit in less than about twenty microseconds of receipt of a predetermined threshold of semiconductor switch current to thereby prevent damage to the at least one semiconductor switching circuit or housing. A method of preventing damage to a semiconductor switching circuit or device is also presented.

### BACKGROUND OF THE INVENTION

1. Field of the Invention

The present invention relates in general to power electronic circuits and, more particularly, to semiconductor switches used in power electronic circuits.

2. Related Art

Inverters used in variable speed drive systems and power converters typically use semiconductor switches such as insulated gate bipolar transistors (IGBT) packaged into IGBT modules.

A problem arises with the use of the IGBT modules where the semiconductor switch looses its voltage blocking capability causing a short circuit. One possible reason for this type of failure is a break down of the semiconductor induced by, e.g., radiant energy. This short circuit of the semiconductor switch, leads, in turn, to a short of the connected equipment which may be a multiphase power grid, a large rotating electrical machine or internal energy storage as for example the DC link capacitor.

Failures such as these can have significant consequences, for example, damage to the IGBT module or to the equipment located physically near the IGBT module.

Referring now to FIG. 1, a typical IGBT module is shown generally at 1. The IGBT module 1 comprises a base plate 2 comprising, e.g., copper, a housing 3 comprising, e.g., a plastic and an insulating ceramics layer 4 comprising, e.g., aluminum oxide layer laminated with a conductive material such as copper. The aluminiumoxide layer may be laminated with copper or other metal in a special process like e.g. direct copper bonding. A solder joint 5 may be employed to affix the base plate 2 to the insulating ceramics layer 4 and power terminals (emitter and collector) 6 are connected via wire bonding to a topside layer (not numbered) of the insulating ceramics layer. The topside layer of the insulating ceramics layer 4 may be etched to provide the IGBT module internal circuit connections. An IGBT chip 7 and a diode chip 8 may be connected by bond wires 9 to the topside layer of the insulating ceramics layer 4. A soft gel 10 may be provided within the housing 3 for encapsulation of the chips 7 and 8.

In case of a failure, a very high current amplitude may be reached within the IGBT module 1. This high current amplitude leads to a thermal overload of the bond wires 9. The melt down of the bond wires 9 initiates an arc that builds up and excessively heats the surrounding insulation soft gel 10. With the arc heating up the module 1 internal structure, the pressure within the housing 3 rises until the housing 1 ruptures. This is usually referred to as an explosion of an IGBT module.

Referring now also to FIG. 2, a circuit diagram of a typical IGBT module including a six pack, three phase, bridge configuration with short circuit is shown generally at 20. Phase connections L₁, L₂ and L₃ from a power source such as the power grid or a large rotating synchronous machine or the like (not shown) are connected to a plurality of IGBT devices 22, 24, 26, 28, 30, 32 such as IGBTs and corresponding diodes and a direct current (dc) link capacitor 34. A short circuit current path 36 is shown where a either the IGBT or the diode of the semiconductor device 24 has lost its blocking capability.

In this case, one or more of the diodes of the remaining functioning bridge devices are forward biased depending on the actual phase voltage. Where the short circuit current path 36 is established, the current is only limited by the grid or load impedance (not shown). The current will flow as long as the power circuit is connected to the grid or load. Typical protection equipment like circuit breakers will need several cycles of the ac frequency to disconnect the failed circuit. During this time span the amount of energy dissipated inside the failed IGBT module 1 will lead to a rupture of the module housing 3. The explosion of the IGBT module will take place within the time span that is typically needed by fuses or circuit breakers to clear the fault.

Standard protection equipment cannot protect the IGBT module from these types of failures. The melting integral of the IGBTs bond wires is usually an order of magnitude lower than the corresponding value of a fuse. Even fast acting fuses, so called semiconductor fuses, which are well positioned to protect thyristor type devices, are not acting fast enough to protect an IGBT module. The explosion cannot be avoided, so common design practice for power converters is to use mechanical separation of modules. One possibility is to use so called Blast Shield to protect neighbor modules. Another solution used within power electronics is to minimize fuse energy let through rating to limit damage within the system. Measures to protect the switch board, like blow off values are used.

Accordingly, to date, no suitable device or method of protecting semiconductor switches from damage during a short circuit failure condition as described above is available.

### BRIEF DESCRIPTION OF THE INVENTION

In accordance with an embodiment of the present invention, a device comprises at least one semiconductor switching circuit connected to a power source and load and at least one breaker switch integrated with the at least one semiconductor switching circuit. The breaker circuit may be connected in series with the at least one semiconductor switching circuit and the at least one breaker switch is configured to create an open circuit within less than about twenty microseconds of receipt of a predetermined threshold of current from the power source to thereby prevent damage to the at least one semiconductor switching circuit.

In accordance with another aspect of the invention a method of preventing damage to a semiconductor switching circuit comprises connecting at least one semiconductor switching circuit to a power source and load; integrating at least one breaker switch with the at least one semiconductor switching circuit; connecting the at least one breaker switch in series with the at least one semiconductor switching circuit; and configuring the at least one breaker switch to create an open circuit in less than about twenty microseconds of receipt of a predetermined threshold of current from the power source to thereby prevent damage to the at least one semiconductor switching circuit.

### BRIEF DESCRIPTION OF THE DRAWINGS

The following detailed description is made with reference to the accompanying drawings, in which:

FIG. 1 is a sectional diagram showing a typical configuration of an IGBT module;

FIG. 2 is a circuit diagram showing a three phase bridge circuit including a failed bridge device and a short circuit current path;

FIG. 3 is a circuit diagram showing a three phase bridge circuit including breaker switches in accordance with one embodiment of the present invention;

FIG. 3A is a sectional diagram showing a portion of an integrated IGBT module in accordance with another aspect of the present invention;

FIG. 4 is a circuit diagram showing a half bridge IGBT module and a breaker switch in accordance with another embodiment of the present invention;

FIG. 5 is a graph showing current versus time flowing through a failed IGBT module.

FIG. 6 is a circuit diagram showing a half bridge IGBT module and a breaker switch in accordance with another embodiment of the present invention;

FIG. 7 is a block diagram illustrating an example switching system, usable with the embodiment of FIG. 6;

FIG. 8 is a circuit diagram showing an IGBT module and a breaker switch in accordance with another embodiment of the present invention;

FIG. 9 is a circuit diagram showing a half bridge IGBT module and a breaker switch configuration in accordance with another embodiment of the present invention;

FIG. 10 is a circuit diagram showing a half bridge IGBT module and a breaker switch configuration in accordance with another embodiment of the present invention; and

FIG. 11 is a circuit diagram showing a single switch IGBT module and a breaker switch configuration in accordance with a further embodiment of the present invention.

### DETAILED DESCRIPTION OF THE PREFERRED EMBODIMENT

One embodiment of the present invention concerns a device and a method for preventing damage to one or more semiconductor switches by providing a breaker switch capable of creating an open circuit condition in less than about twenty microseconds of determination of an over current condition in a circuit carrying current to the semiconductor switch(es). In one particular embodiment, a microelectromechanical system (MEMS) breaker switch may be integrated into an insulated gate bipolar transistor (IGBT) module. In case a failure is detected by the main inverter control system, the MEMS breaker switch is commanded to disconnect the IGBT from all loads or power sources. Use of the MEMS breaker switch allows the current to the IGBT to be interrupted in less than about twenty microseconds (μs), especially within the IGBTs rated short circuit withstand time. By this method an explosion of the IGBT module housing is avoided. The risk for damaging neighbor devices is minimized. Bulky external protection devices, such as circuit breakers or fuses can be avoided. Auxiliary elements employed with a MEMS breaker switch also may be integrated into an IGBT module.

It will be appreciated that a MEMS based switch is a fast acting switch but it cannot break high currents. Accordingly, a MEMS switch may be connected in a circuit, e.g., configured such that the MEMS switch switches when a current level is nearly zero or, e.g., configured to comprise an external circuit configured to reduce a current level in the MEMS switch to zero. One exemplary document describing use of an external circuit appropriately configured using MEMS technology is found in US Patent Publication No. 20070139829A1 which is assigned to the General Electric Company.

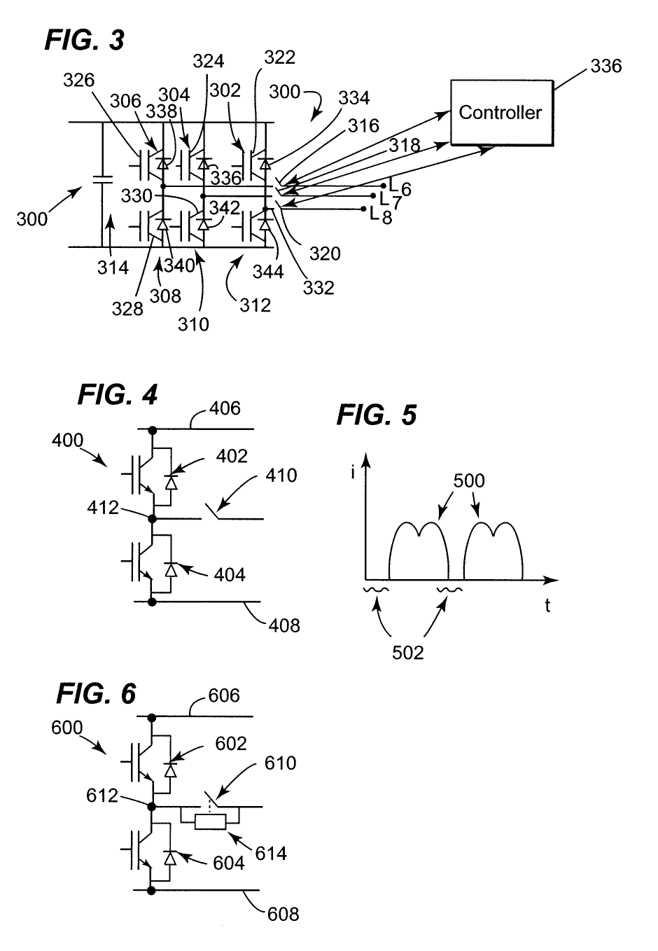

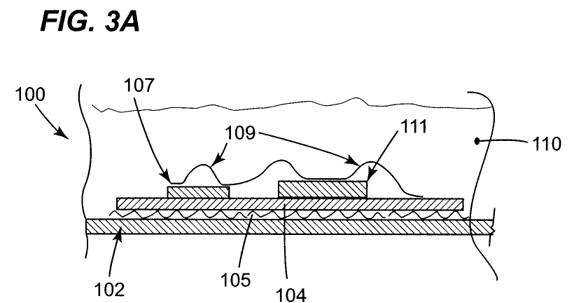

Referring now to FIG. 3, a circuit comprising a breaker switch, in accordance with a first embodiment of the present invention, is illustrated generally at 300. In this embodiment, the circuit 300 comprises phase connections L₁, L₂ and L₃, semiconductor switching circuits such as IGBT devices 302 through 312, a direct current (DC) link capacitor 314 and breaker switches 316, 318 and 320.

The phase connections L₁, L₂ and L₃ may be in circuit with a power source such as the public grid or a rotating synchronous machine (not shown). The three phase bridge is using IGBT devices 302 through 312 and parallel connected diodes 334 through 344 in all switch positions.

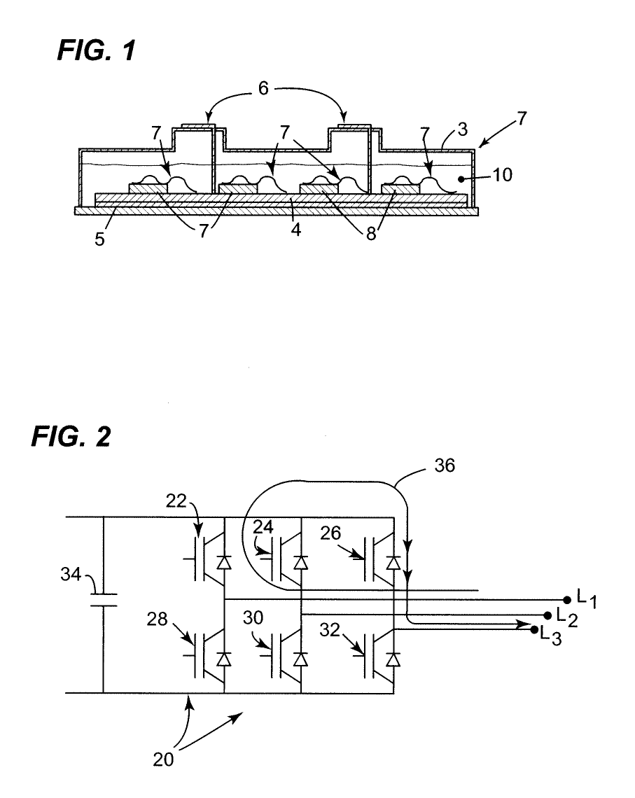

Each breaker switch 316, 318 and 320 comprises a MEMS switch that is respectively integrated into each phase connection L1, L2 and L3. Integrating of the breaker switches 316, 318 and 320 comprises the formation of the breaker switches and the IGBT in a single module or housing. It is intended that the term “integrated”, as used in this document, means an assembly of one or more IGBT and/or one or more diode chips into one module housing. FIG. 3A illustrates a portion of an exemplary integrated IGBT module 100 in accordance with an embodiment of the present invention. As shown therein, the IGBT module 100 may be similar to the IGBT module 1 described above in connection with FIG. 1 and as such similar elements are labeled similarly accepting that a one hundred prefixes each reference number. A difference is in that a breaker switch 111, such as a MEMS switch, is connected by wire bonds 109 to an IGBT chip 107. In this way, the breaker switch 111 is integrated with the IGBT chip in the IGBT module 100.

Referring now to FIGS. 3 and 5 and in the example of a failure of one of the diodes 334 through 344, a typical current waveform 500 for a short circuit is shown in FIG. 5. The waveform 500 features natural zero current phases 502 that can be identified easily by an appropriately configured control circuit 336 (FIG. 3). Referring again also to FIG. 3, the control circuit 336 is configured to switch the breaker switches 316, 318 and 320 upon sensing the zero current phases 502 of the waveform 500. It will be understood that the control circuit 336 may comprise a motor controller circuit. In another embodiment control circuit 336 may be integrated with the inverter control circuit or the inverter protection circuit. Upon receiving a command from the control circuit 336, each breaker switch 316, 318 and 320 will switch open within twenty microseconds to prevent damage to the IGBT devices 302 through 312 or the diodes 334 through 344.

Another embodiment of a circuit comprising a breaker switch in accordance with the present invention is shown generally at 400 in FIG. 4. The circuit 400 comprises a pair of IGBT devices 402 and 404 connected in a half bridge configuration. The conductors 406 and 408 are representing the DC link connection. A breaker switch 410 may be connected in series to the AC terminal of the half bridge 412 and may comprise a MEMS switch. The breaker switch 410 may be controlled by a control circuit (not shown) in a similar manner to that described above and illustrated in FIG. 3.

In another embodiment, a circuit that is configured to reduce a current through a breaker switch to almost zero is shown generally at 600 in FIG. 6. The circuit 600 comprises a pair of IGBT devices 602 and 604 connected in a half bridge configuration. The conductors 606 and 608 are representing the DC link connection. A breaker switch 610 may be connected in series with the AC terminal of the half bridge 612 and may comprise a MEMS switch. The breaker switch 610 may be controlled by a control circuit (not shown) in a similar manner to that described above and illustrated in FIG. 3. In this embodiment an additional switching circuit 614 may be provided which provides a separate path for the current to pass instead of through the breaker switch 610. By this means the MEMS current is brought to almost zero to support the switches opening.

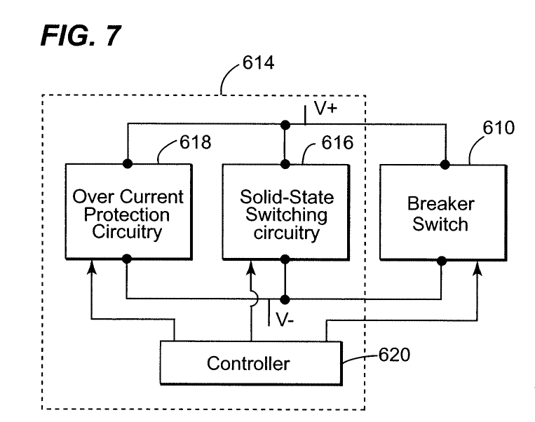

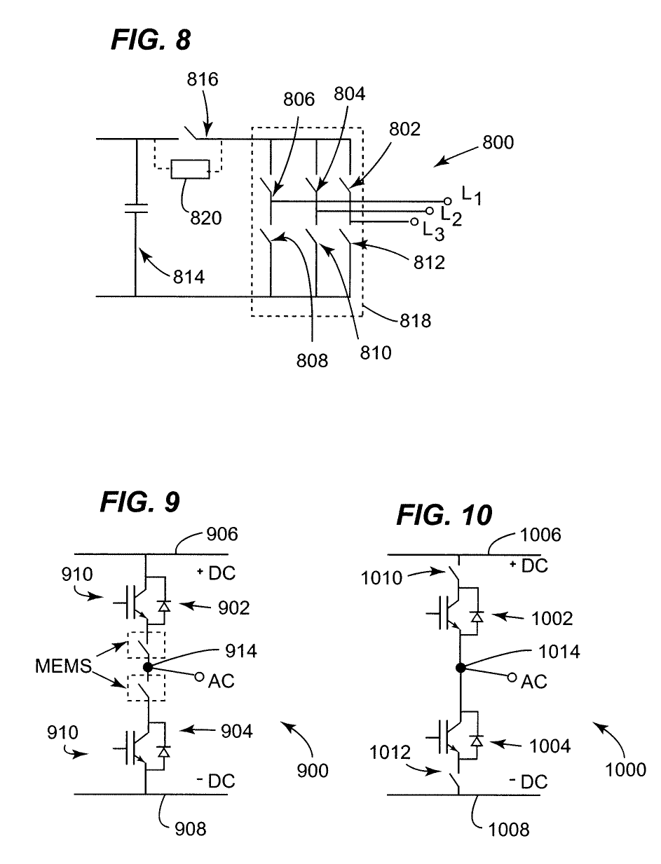

FIG. 7 is a block diagram representation of the switching circuit 614 that connects in a parallel circuit with the breaker switch 610 that comprises a MEMS-based switch. The switching circuit 614 may comprises a solid-state switching circuitry 616, an over-current protection circuitry 618 and a controller 620. In another embodiment of the invention the over-current protection circuit and/or the control circuit 620 may be integrated with the inverters control or protection circuitry.

The controller 620 may be coupled to the breaker switch 610, the solid-state switching circuitry 616 and the over-current protection circuitry 618. To reduce the current through the breaker switch 610, the controller 620 may be configured to selectively transfer current back and forth between the breaker switch and the solid state switching circuitry by performing a control strategy configured to determine when to actuate over-current protection circuitry 618, and also when to open and close each respective switching circuitry, such as may be performed in response to load current conditions appropriate to the current-carrying capabilities of a respective one of the switching circuitries and/or during fault conditions that may affect the switching system. It is noted that in such a control strategy it is desirable to be prepared to perform fault current limiting while transferring current back and forth between the respective switching circuitries 610 and 616, as well as performing current limiting and load de-energization whenever the load current approaches the maximum current handling capacity of either switching circuitry.

A system embodying the foregoing example circuitry may be controlled such that the surge current is not carried by the breaker switch 610 comprising a relatively low level current rated MEMS based switching circuitry and such a current is instead carried by solid-state switching circuitry 616. The steady-state current would be carried by breaker switch 610, and over-current and/or fault protection would be available during system operation through over-current protection circuit 618.

In accordance with another embodiment of the present invention a circuit 800 comprises phase connections L₁, L₂ and L₃, switches 802 through 812 each comprising a parallel connection of one or more IGBT devices and diode devices, a DC link capacitor 814 and a breaker switch 816. A switching circuit 820 similar to the switching circuit 614 may be provided.

The phase connections L₁, L₂ and L₃ may be in circuit with a power source such as the power grid or a large rotating synchronous machine or the like (not shown) that may have a very high short circuit current rating. Each IGBT and corresponding anti parallel diode, in the bridge 818, are shown as switches only.

The breaker switch 816 comprises a MEMS switch and is used to disconnect the bridge circuit 818 from the DC link capacitor 814 to avoid discharging of its energy into the failed module. In this embodiment, an advantage of using a MEMS switch integrated into the module is that stray inductance is minimized due to the small size of the unit and its tight integration with the IGBT module.

Referring now to FIG. 9, another embodiment of a circuit in accordance with the present invention is shown generally at 900. Circuit 900 represents a half bridge configuration comprising a pair of IGBT devices 902 and 904 and parallel connected diodes 902 and 904. Two breaker switches 910 and 912, each comprising a MEMS switch, are connected between the IGBT devices 902 and 904. A junction 914 is located between the breaker switches 902 and 904 that is connected with AC current. Such an arrangement, it will be appreciated, provides more opportunity to switch off the breaker switches 910 and 912 during natural zero current conditions of a failure waveform (FIG. 5). This would speed up the current interruption. By means of this the use of a switching circuit (such as 614 or 820, described above) in parallel to the breaker switches 910 and 912 may be omitted.

In a further embodiment shown in FIG. 10, a circuit 1000 may be similar to the circuit 900 of FIG. 9, although, the breaker switches 1010 and 1012 are connected into different position.

In a further embodiment (not shown) the breaker switches are series connected to the IGBT emitters.

In a further embodiment (not shown) the breaker switches are series connected to the IGBT collectors.

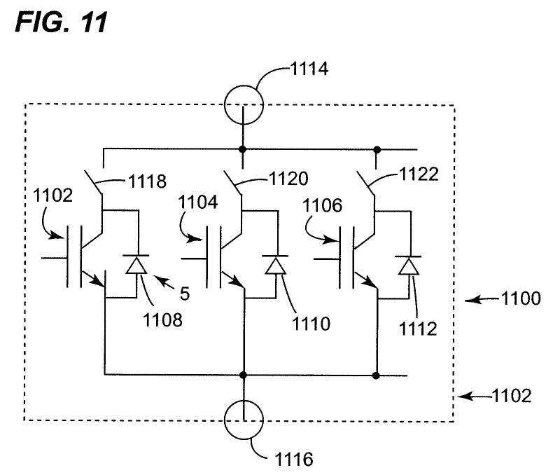

A circuit in accordance with a further embodiment is shown generally at 1100 in FIG. 11. The circuit 1100 comprises a single switch IGBT module comprising a multiple of parallel connected IGBT device 1102 through 1106 and a multiple of diodes 1108 through 1112. This type of IGBT module is especially suited for relatively high power/current ratings. In this embodiment one breaker switch is series connected to each single internal branch (1102 and 1108) of the module. Using a breaker switch 1118, 1120 and 1122, each of which may comprise a MEMS switch, in each of the parallel branches enables, e.g., a failed IGBT chip 1102 or diode 1108 to be disconnected while operating the remaining IGBTs 1104 and 1106 and diodes 1110 and 1112 at a reduced current rating. Accordingly, a design featuring n+1 redundancy is also a viable option.

In an further embodiment similar to FIG. 11 the breaker switches 1118 through 1122 are series connected to the IGBT emitters.

The above described principle of individual breaker switches may also be applied to IGBT modules in half bridge configuration or IGBT modules in six-pack configuration.

It will be appreciated that each of the circuits described above may also be applied for IGBT modules in single switch configuration, in half bridge configuration, six-pack configurations or combinations thereof. Also the above described principals may be applied to other module configurations like copper modules or the like.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

What is claimed is:

1. A device, comprising:
a housing;
at least one semiconductor switching circuit connected to a power source and a load and the at least one semiconductor switching circuit being located within the housing; and
at least one breaker switch integrated with the at least one semiconductor switching circuit and being connected in series with the at least one semiconductor switching circuit, the at least one breaker switch being configured to create an open circuit in less than about twenty microseconds of receipt of a predetermined threshold of the semiconductor switch current to thereby prevent damage to the at least one semiconductor switching circuit.

2. The device of claim 1, wherein the at least one semiconductor switching circuit comprises an insulated gate bipolar transistor (IGBT) and/or a diode.

3. The device of claim 2, wherein the at least one breaker switch comprises a microelectromechanical system (MEMS) switch.

4. The device of claim 3, wherein the at least one semiconductor switching circuit comprises a plurality of semiconductor switching circuits each comprising IGBTs and/or diodes.

5. The device of claim 4, wherein:
the at least one breaker switch comprises a plurality of breaker switches;
the semiconductor switching circuits are arranged to form a bridge circuit for converting multiphase AC into DC, or DC into multiphase AC, and each of the breaker switches are interposed between a phase of the multiphase AC and a pair of semiconductor switching circuits; and
the device further comprises a controller configured to control opening of each of the breaker switches in the event of a failure of one of the semiconductor switching circuits to prevent damage to the other semiconductor switching circuits or the housing.

6. The device of claim 5, wherein the controller identifies a failure of one of the semiconductor switching circuits and synchronizes the breaker opening with a waveform zero current.

7. The device of claim 4, further comprising an additional switching circuit that substantially reduces current from passing through the at least one breaker switch.

8. The device of claim 7, wherein the additional switching circuit comprises:
a solid state switching circuitry;
an over current protection circuitry; and
a controller configured to communicate with the breaker switch, the solid state switching circuitry and the over current protection circuitry whereby current is passed through the solid state switching circuitry rather than through the breaker switch.

9. The device of claim 8, wherein one or more of a controller functions, e.g. over current detection, is integrated with the inverter control system.

10. A method of preventing damage to a semiconductor switching circuit, comprising:
connecting at least one semiconductor switching circuit to power source;
integrating at least one breaker switch with the at least one semiconductor switching circuit in a single housing;
connecting the at least one breaker switch in series with the at least one semiconductor switching circuit;
configuring the at least one breaker switch to create an open circuit in less than about twenty microseconds of receipt of a predetermined threshold of semiconductor switch current to thereby prevent damage to the at least one semiconductor switching circuit or the housing.

11. The method of claim 10, wherein the at least one semiconductor switching circuit comprises an insulated gate bipolar transistor (IGBT) and/or a diode.

12. The method of claim 11, wherein the at least one breaker switch comprises a microelectromechanical system (MEMS) switch.

13. The method of claim 12, wherein the at least one semiconductor switching circuit comprises a plurality of semiconductor switching circuits each comprising IGBTs and/or diodes.

14. The method of claim 13, wherein:
the at least one breaker switch comprises a plurality of breaker switches;
the semiconductor switching circuits are arranged to form a bridge circuit for converting multiphase AC into DC, or DC into multiphase AC, and each of the breaker switches are interposed between a phase of the multiphase AC and a pair of semiconductor switching circuits; and
the method further comprises configuring a controller to control opening of each of the breaker switches in the event of a failure of one of the semiconductor switching circuits to prevent damage to the other semiconductor switching circuits.

15. The method of claim 14, wherein configuring the controller further comprises identifying a failure of one of the semiconductor switching circuiting circuits via a waveform including a zero current component.

16. The method of claim 14, wherein an opening command of the at least one breaker switch is synchronized with the currents waveform zero value.

17. The method of claim 12, further comprising providing an additional switching circuit to substantially reduce current from passing through the at least one breaker switch.

18. The device of claim 17, wherein the additional switching circuit comprises:
a solid state switching circuitry;
an over current protection circuitry; and
a controller configured to communicate with the breaker switch, the solid state switching circuitry and the over current protection circuitry whereby current is passed through the solid state switching circuitry rather than through the breaker switch.
